(19) United States
(12) Patent Application Publication
(10) Pub. No.: US 2010/0068465 A1
(43) Pub. Date: Mar. 18, 2010

(54) HOUSING AND METHOD FOR MAKING THE HOUSING

(75) Inventors: JONG-YI SU, Shindian (TW); CHENG-SHIN CHEN, Shindian (TW); REN-NING WANG, Shenzhen City (CN); YUAN-ZHU ZHOU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) LIMITED, Kowloon (HK)

(21) Appl. No.: 12/539,693

(22) Filed: Aug. 12, 2009

(30) Foreign Application Priority Data
Sep. 18, 2008 (CN) 200810304549.4

(51) Int. Cl. B32B 3/30; C25D 5/02

(52) U.S. Cl. 428/166; 205/118

(57) ABSTRACT

A housing, comprising: a substrate; a paint coating formed on the substrate, the paint coating defining a plurality of through grooves therein; and a metal coating, the metal coating being formed in the through grooves. A method for making housing, comprising: providing a substrate; applying a paint coating on the substrate by spray painting; forming a plurality of through grooves on the paint coating by etching; and forming a metal coating in the through grooves by electroplating.

### BACKGROUND

1. Technical Field

The present disclosure relates to a housing and a method for making the housing.

2. Description of Related Art

Electroplating is a typical surface treatment method for forming metal coatings on plastic housings. The metal coating presents attractive metallic appearance. However, the metal coating formed on the whole surface of the housing is prone to block electromagnetic wave and interfere with radio signals. To avoid this problem, parts of the surface of the housing are masked with paint prior to the electroplating to prevent the masked surface from being electroplated during the electroplating process. The paint is then removed after the electroplating process. The additional process of removing the paint increases the time and cost. Furthermore, the non-electroplated region of the housing is hard to precisely mask, which is difficult to achieve a precise decorative pattern coating on the housing.

Therefore, there is room for improvement within the art.

### BRIEF DESCRIPTION OF THE DRAWINGS

Many aspects of the housing and method for making the housing can be better understood with reference to the following drawings. The components in the drawings are not necessarily drawn to scale, the emphasis instead being placed upon clearly illustrating the principles of the housing and method for making the housing. Moreover, in the drawing like reference numerals designate corresponding parts throughout the several views.

FIG. 1 is a cross-sectional view of a present exemplary embodiment of a housing.

FIG. 2 is a flow chart of a present exemplary embodiment of a method for making the housing shown in FIG. 1.

### DETAILED DESCRIPTION

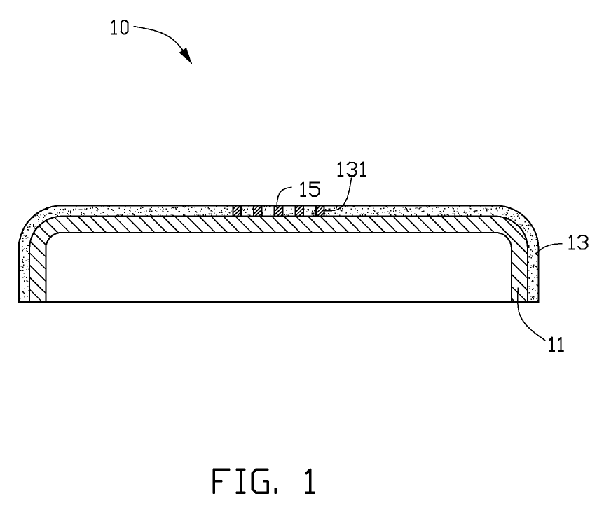

Referring to FIG. 1, in a present embodiment, a housing 10 includes a substrate 11 and a paint coating 13 formed on the substrate 11.

The substrate 11 is made of plastic. The plastic may be acrylonitrile-butadiene-styrene (ABS) or a mixture of acrylonitrile-butadiene-styrene (ABS) and polycarbonate (PC).

The paint coating 13 may be an acrylic resin paint coating applied by spray painting. The thickness of the paint coating 13 is about 15-30 μm. The paint coating 13 is defined by a predetermined number of through grooves 131 formed by laser etching. The through grooves 131 define a predetermined pattern of the housing 10. A metal coating 15 is formed in the through grooves 131. The metal coating 15 may be a single chromium coating or a composite coating, e.g., copper-chromium coating, or copper-palladium-chromium coating, etc. The thickness of the metal coating 15 can either be equal to or thicker than the thickness of the paint coating 13. The metal coating 15 may be formed by electroplating.

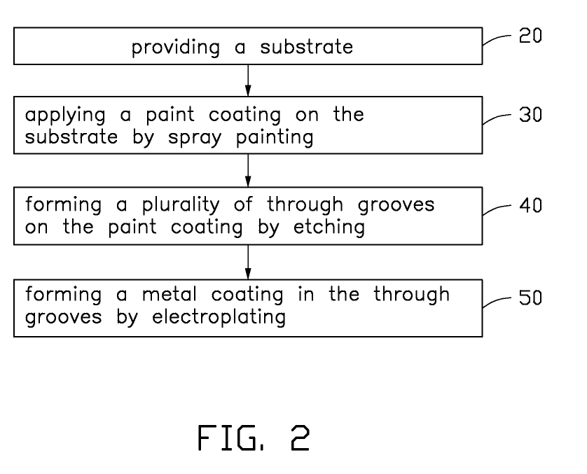

A method for making the housing 10 is provided. Referring to FIG. 2, the method may comprise the steps 20-50.

In step 20, a substrate 11 is provided. The substrate 11 may be a plastic substrate formed by molding. The plastic may be acrylonitrile-butadiene-styrene (ABS) or a mixture of acrylonitrile-butadiene-styrene (ABS) and polycarbonate (PC).

In step 30, a paint coating 13 is applied on one surface of the substrate 11 by spray painting. The paint used in forming the paint coating 13 may include acrylic resin paint. The paint may further contain pigment according to a predetermined color of the housing 10. The thickness of the paint coating 13 is about 15-30 μm.

In step 40, a plurality of through grooves 131 are etched in the paint coating 13. The grooves 131 are etched by using a laser to irradiate and melt a portion of the paint coating 13 according to a predetermined pattern. The laser used has a power of about 10-80 watts. The path of irradiating the paint coating 13 to form the through grooves 131 can be recomposed efficiently depending on the predetermined pattern design requirement.

In step 50, a metal coating 15 is formed in the through grooves 131. The metal coating 15 may be formed by electroplating. The electroplating may include the follow steps:

Firstly, the substrate 11 having the paint coating 13 is dipped in a roughening solution to roughen the exposing surface of the substrate 11 having the through grooves 131. The roughening solution may be chromium acid, a mixture of chromium acid and sulfuric acid or potassium permanganate solution. The exposing surface of the substrate 11 will chemically react with the compounds in the roughening solution thereby becoming roughened. The roughened surface of the substrate 11 would enhance the adhesion of the metal coating 15 to the substrate 11 in a subsequent process. After roughening, the roughened surface of the substrate 11 undergoes a neutralization treatment and rinsed with water.

Secondly, the roughened surface of the substrate 11 is undergoes a first metallization process, thereby yielding a single metalized surface. The first metallization process is performed by dipping the roughened substrate 11 in a solution containing hydrochloric acid, polyamide acid and noble metal irons (e.g. palladium iron, etc.) for about 1-5 minutes. During the first metallization process, the noble metal iron deoxidizes to noble metal and deposits on the roughened surface of the substrate 11. The noble metal deposited is distributed on partial region of the roughened surface.

Thirdly, the single metalized surface of the substrate 11 is undergoes a second metallization, thereby yielding a doubled metalized surface. The second metallization process is carried out by dipping the substrate 11 in a solution containing copper iron, formaldehyde, sodium hydroxide, and ethylene diamine tetraacetic acid. During the second metallization process, the copper iron contained in the solution deoxidizes to copper to deposit around the noble metal to form a copper coating on the roughened surface.

Fourthly, the substrate 11 is electroplated to form the metal coating 15 on the copper coating. The metal coating 15 may be a single chromium coating or a composite coating, e.g., copper-chromium coating, or copper-palladium-chromium coating, etc. The palladium coating may have a thickness of about 2-8 μm. The chromium coating may have a thickness of about 0.1-2 μm. The chromium coating can enhance the abrasion and corrosion resistance of the metal coating 15.

The exemplary method for making the housing 10 etches through grooves 131 in predetermined region of the paint coating 13 first before forming a metal coating 15 by electroplating in the through grooves 131 to create predetermined patterns on the housing 10. The decorative metal coating 15 does not block electromagnetic wave nor interfere with radio signals. The method of making the housing 10 utilizes laser to etch the paint coating 13 to form through grooves 131, which has a higher efficiency at recomposing the through grooves 131 depending on the product design requirements.

It is believed that the present embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A housing, comprising:
a substrate;
a paint coating formed on the substrate, the paint coating defining a plurality of through grooves therein; and
a metal coating, the metal coating being formed in the through grooves.

2. The housing as claimed in claim 1, wherein the through grooves is formed by laser etching.

3. The housing as claimed in claim 1, wherein the metal coating is a single coating or a composite coating, the thickness of the metal coating either be equal to or thicker than the paint coating.

4. The housing as claimed in claim 3, wherein the metal coating is formed by electroplating.

5. The housing as claimed in claim 1, wherein the substrate is made of plastic material of acrylonitrile-butadiene-styrene or a mixture of acrylonitrile-butadiene-styrene and polycarbonate.

6. The housing as claimed in claim 1, wherein the paint coating is an acrylic resin paint coating, the thickness of the paint coating is about 15-30 μm.

7. A method for making housing, comprising: providing a substrate;
applying a paint coating on the substrate by spray painting;
forming a plurality of through grooves on the paint coating by etching; and
forming a metal coating in the through grooves by electroplating.

8. The method as claimed in claim 7, wherein the substrate is made of plastic material of acrylonitrile-butadiene-styrene or a mixture of acrylonitrile-butadiene-styrene and polycarbonate.

9. The method as claimed in claim 7, wherein the paint coating is an acrylic resin paint coating, the thickness of the paint coating is about 15-30 μm.

10. The method as claimed in claim 7, wherein the through grooves are formed by laser etching at a power of 10-80 watts.

11. The method as claimed in claim 7, wherein the step of forming the metal coating includes the steps of: roughening the exposed surface of the substrate having the through grooves; metalizing the roughened surface to yield a single metalized surface; metalizing the single metalized surface to yield a double metalized surface; and electroplating the double metalized surface to form the metal coating.
